(19) United States
(12) Patent Application Publication
(10) Pub. No.: US 2008/0272981 A1
(43) Pub. Date: Nov. 6, 2008

(54) Low Profile Helical Planar Radio Antenna with Plural Conductors

(76) Inventors: Darryl F. Gagne, Covington, LA (US); Jeffrey Gallagher, Covington, LA (US)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/915,639

(22) PCT Filed: May 24, 2006
(86) PCT No.: PCT/US2006/019912

§ 371 Date: Jun. 23, 2008

Related U.S. Application Data
(60) Provisional application No. 60/684,952, filed on May 27, 2005.

(51) Int. Cl. H01Q 1/36; H01Q 9/04; H01P 11/00

(52) U.S. Cl. 343/895; 343/700 MS; 29/600

(57) ABSTRACT

A low profile, compact planar antenna having an approximately flat, dual helical or helix shape is affixed to a supporting substrate. The resonant frequency of the device is determined by parameters including and not limited to length, width, and pitch angle of the helix. An additional helical element is added to induce a second resonant frequency and increase bandwidth. The antenna has an omni-directional radiation pattern, is highly efficient, and is provided in a compact profile suitable for use in a small battery operated device, such as water, gas or electricity meters as well as industrial sensors and security devices.

### CROSS REFERENCE TO RELATED APPLICATIONS

The present application is related to U.S. patent application Ser. No. 10/662,530, entitled “ENHANCED WIRELESS PACKET DATA COMMUNICATION SYSTEM, METHOD, AND APPARATUS APPLICABLE TO BOTH WIDE AREA NETWORKS AND LOCAL AREA NETWORKS,” filed Nov. 19, 2004, the entire contents of which is incorporated herein by reference.

### BACKGROUND OF THE INVENTION

1. Field of the Invention

The invention relates to a helical antenna for use in low power wireless devices and to packaging for low power wireless devices.

2. Description of the Related Art

An antenna of large size may be impractical for portable wireless devices. The dimensions of conventional helical antennas, such as length of the helix, are usually relatively small when compared to the wavelength of the frequency of operation.

A conventional helical or helix antenna includes a conducting wire wound in a helix shape similar to that of a spring. Frequently, a helical antenna is used in conjunction with a large ground plane placed perpendicular to the axis of the helix (i.e., the helix coiling direction) that can take on various shapes and sizes.

The intrinsic geometric nature of the helical antenna affects the antenna's radiation resistance, a key factor in designing antennas. The geometrical configuration of normal helical antennas is described by Balanis, Antenna Theory 3rd ed., Chapter 10, pp. 566-576 (Wiley 2005). A conventional helical antenna which is electrically desirable and mechanically practical has been very difficult to obtain. As a result, conventional helical antenna designs suffer from narrow bandwidths at high frequencies where wide bandwidths are preferred.

In the art, it is common to change various parameters inherent to helical antennas in order to increase the bandwidth. This comes at a cost to the antennas radiation efficiency. For example, expanding or constricting the size of the helix or adding impedance matching elements in series with the antenna's RF source may degrade performance. The efficiency of antennas, however, plays an important role in the operation of low power wireless devices, including those operating from battery power.

One background approach that attempts to improve performance of a helical antenna, adds a second radiating element. This technique can increase the bandwidth of operation of the helical antenna without compromising the performance or size of the antenna, as described in Noguchi, K.; Betsudan, S. I.; Katagi, T.; Mizusawa, M., IEEE Trans. APS, Vol. 51 No. 9, pp. 2176-2181 (September 2003). However, that conventional approach relies on a two dimensional ground plane that is perpendicular to the helical coil direction of the helical antenna. Further, that background approach indicates that it is difficult to reduce a characteristic impedance of the stub with a two wire helical antenna that uses wires with circular cross sections because of the high characteristic impedance of those circular cross section wires. Thus, that background approach suggests flat wire strips arranged such that the planes of each flat wire strip is displaced from, but parallel to, the plane of the other strip. Further the reference describes a two strip configuration that has two flat conducting strips separated by a thin sheet of dielectric material parallel to the planes of the strips. However, the two flat strips separated by a dielectric material in that configuration may not be easily manufactured and the resulting helical antenna structure may be difficult to attach to a feed point and/or a ground plane.

Further, the dual conducting metal strip helical antenna described in this background approach also relies on a two dimensional ground plane that is in the plane that is perpendicular to the direction of the helical coiling. By requiring the use of a two dimensional ground plane in the plane perpendicular to the helical coil direction of coiling, it is not easy to manufacture the background approach and it is not easy for the background approach to be made in a compact fashion.

Further, there is a problem in the background art of transceivers that must operate from a location having poor radio signal transmission characteristics, such as a buried structure or a structure enclosed or partially enclosed by metal or soil or other radio transmission inhibiting materials.

In addition there are problems with transceivers, receivers or transmitters that are temporarily or permanently installed in locations having poor radio signal transmission characteristics and possibly being subject to harsh environments including moisture and extreme temperatures. In particular, background solutions for transceivers in such locations are plagued by problems due to the contraction and expansion of water, the accumulation of rust and other problems associated with exposure to the elements.

### SUMMARY OF THE INVENTION

According to one aspect of the present invention, there is provided a novel antenna, comprising a printed circuit board having opposed first and second surfaces; first and second conductive traces formed on the first and second surfaces, wherein, the first traces are longitudinally extending and parallel to each other, and the second traces are longitudinally extending and parallel to each other, at least one pair of the first traces or one pair of the second traces are shorted together, and plural of the first traces have ends connected to ends of respective of the second traces through vias that pass through the printed circuit board. The antenna also includes third and fourth conductive traces having first ends respectively connected to a signal feed point and a ground point and second ends connected to respective of the first and second traces.

According to another aspect of the present invention there is provided a novel method of making an antenna that includes a printed circuit board having opposed first and second surfaces; first and second conductive traces formed on the first and second surfaces, wherein, the first traces are longitudinally extending and parallel to each other, and the second traces are longitudinally extending and parallel to each other, at least one pair of the first traces or one pair of the second traces are shorted together, and plural of the first traces have ends connected to ends of respective of the second traces through vias that pass through the printed circuit board. The antenna also includes third and fourth conductive traces having first ends respectively connected to a signal feed point and a ground point and second ends connected to respective of the first and second traces.

According to another aspect of the present invention there is provided a novel electronic device, comprising a moisture resistant container configured to attach to a lid of a subterranean enclosure, and a printed circuit having an antenna and electronic components mounted inside the container.

According to another aspect of the present invention there is provided a novel method of manufacturing an electronic device, comprising steps of partially filling a moisture resistant shell with a foam; inserting a printed circuit board having an antenna into the shell such that the antenna is covered by the foam; and filling the portion of the shell that does not have foam with a potting material to hermetically isolate a region inside the shell including the printed circuit board from the outside of the shell.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is a top view of a package according to an embodiment of the present invention;

FIG. 1B is a front view of the package according to an embodiment of the present invention;

FIG. 1C is a side view of the package according to an embodiment of the present invention;

FIG. 1D is a section view showing section AA from FIG. 1B of the present embodiment;

FIG. 1E is a detailed view of the package contents according to the present embodiment;

FIG. 2A is a top view of a packaging embodiment according to the present invention;

FIG. 2B is a detailed front view of the packaging according to the present embodiment;

FIG. 2C is a detailed bottom view of an embodiment of the packaging according to the present invention;

FIG. 2D is a side view of a coaxial antenna clip embodiment according to the present invention;

FIG. 2E is a perspective view of an embodiment of the present invention;

FIG. 2F is a detailed view of the contents of the packaging of the present invention;

FIG. 2G is a detailed view of an embodiment according to the present invention;

FIG. 2H is a detailed view of a post used in a packaging embodiment of the present invention;

FIG. 3A is a perspective view of a further embodiment of packaging according to the present invention;

FIG. 3B is a front view of the embodiment according to the present invention;

FIG. 3C illustrates a manufacturing process of the packaging according to the present invention;

FIG. 3D is a detailed view of a support post in the embodiment of the present invention;

FIG. 4A is a detailed view of a further embodiment of the present invention;

FIG. 4B is a detailed view of a further embodiment of the present invention;

FIG. 4C is a detailed view of a further embodiment of the present invention;

FIG. 4D is a detailed view of a further embodiment of the present invention;

FIG. 5A illustrates a method of manufacturing a package according to the present invention;

FIG. 5B illustrates an example of manufacturing a package according to an embodiment of the present invention;

FIG. 6A illustrates manufacturing according to an embodiment of the present invention;

FIG. 6B illustrates manufacturing according to the present invention;

FIG. 6C illustrates manufacturing according to an embodiment of the present invention;

FIG. 6D illustrates manufacturing according to an embodiment of the present invention;

FIG. 7A illustrates in a manufacturing process according to an embodiment of the present invention;

FIG. 7B illustrates a step in a manufacturing process according to an embodiment of the present invention;

FIG. 8A illustrates a side view of an embodiment of the present invention;

FIG. 8B illustrates a front view of an embodiment of the present invention;

FIG. 9 is a detailed view of a further embodiment of the present invention;

FIG. 10 illustrates a use of an embodiment of the present invention;

FIG. 11A illustrates a manufacturing according to an embodiment of the present invention;

FIG. 11B illustrates manufacturing according to an embodiment of the present invention;

FIG. 12A illustrates a use of an embodiment of the present invention;

FIG. 12B illustrates a detailed view of an embodiment of the present invention;

FIG. 13A illustrates an embodiment of the present invention;

FIG. 13B illustrates an embodiment of the present invention;

FIG. 14 illustrates an embodiment of the present invention;

FIG. 15 illustrates a detailed view of an embodiment of the present invention;

FIG. 16 is a perspective view of an embodiment of the present invention;

FIG. 17 is a perspective view of an embodiment of the present invention;

FIG. 18 illustrates using an embodiment of the present invention;

FIG. 19 is an alternate embodiment of the present invention;

FIG. 20 is an alternate embodiment of the present invention;

FIG. 21A is an alternate embodiment of the present invention;

FIG. 21B is a perspective view of batteries in an embodiment of the present invention;

FIG. 22 is an alternate embodiment of the present invention;

FIG. 23A is an alternate embodiment of the present invention;

FIG. 23B is an alternate embodiment of the present invention;

FIG. 24A is an alternate embodiment of the present invention;

FIG. 24B is a side view of a circuit card and clamp according to an embodiment of the present invention;

FIG. 24C is a partial view of a leader according to an embodiment of the present invention;

FIG. 25 is an alternate embodiment of the present invention;

FIG. 26A is an alternate embodiment of the present invention;

FIG. 26B is a detailed view of battery assembly wiring according to an embodiment of the present invention;

FIG. 27A is an alternate embodiment of the present invention;

FIG. 27B is an alternate embodiment of the present invention;

FIG. 27C is an alternate embodiment of the present invention;

FIG. 27D is an alternate embodiment of the present invention;

FIG. 28A is an alternate embodiment of the present invention;

FIG. 28B is an alternate embodiment of the present invention;

FIG. 28C is an alternate embodiment of the present invention.

### DESCRIPTION OF THE PREFERRED EMBODIMENTS

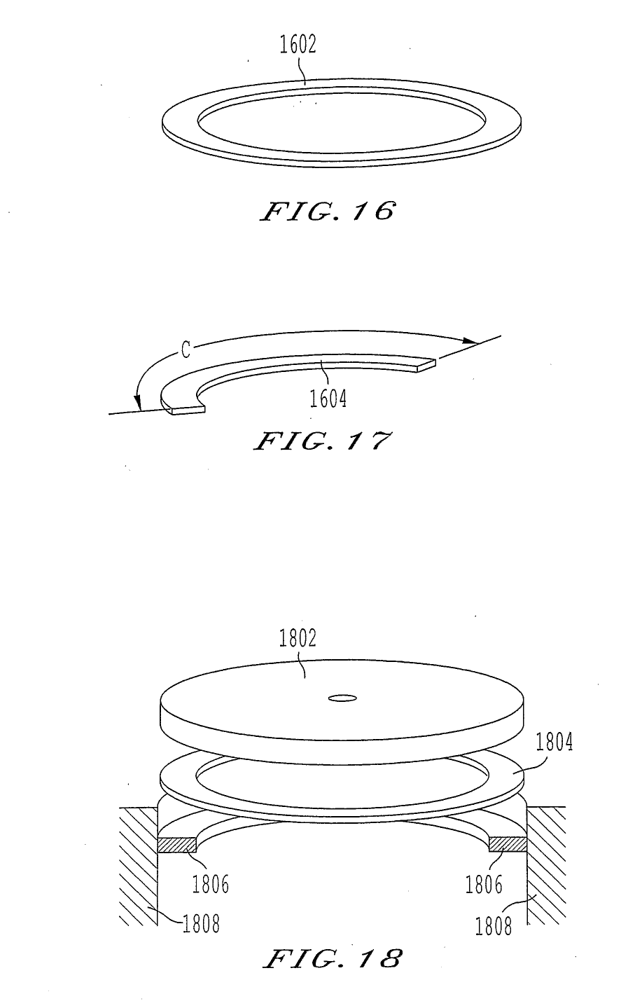

Referring now to the drawings, wherein like reference numerals designate identical or corresponding parts throughout the several views, and more particularly to FIGS. 13A, 13B and 14 thereof which describe an embodiment of the invention that includes a supporting substrate core 1302 on which an electrical conductor 1304, such as a copper trace, wire, or strip, is formed, applied, fixed, etched or otherwise arranged. The electrical conductors on the substrate are longitudinally extending and substantially straight, as shown in the drawings, except for the traces that connect to the feed point 1305 and ground point 1306, which each include a bend of a predetermined angle.

The resonant frequency of the antenna may be determined by the length to wavelength ratio of a feed strip. For example, the length used in one embodiment is 0.75 the wavelength of the operating frequency. This ratio is used as the length of the conducting trace for the first helix 1300 in the present embodiment, which is referred to as the feed strip. The first helix 1300 is connected to the feed point 1305 of an RF transmitter (not shown).

A second helix 1304 of similar length is also used in the antenna. One end of the second helix is terminated to ground and referred to as the ground point 1306. The feed point 1305 is separated by a distance D from the ground point of the second helix. Selection of an appropriate distance D helps to tune the antenna to the proper resonant frequency. Further, the first helix 1300 and second helix 1304 are shorted together. For example, as in this embodiment, the first and second helixes are shorted together at the far end of the helixes, at position 1303. Alternatively, the helixes may be shorted together at one or more other locations along their paths.

The inventors of the present invention have also discovered that it is preferable for transceivers that operate from within buried or partially enclosed structures with radio transmission inhibiting materials to have certain characteristics. In particular, the inventors discovered that the antennas of those transceivers should optimally have an omni-directional radiation pattern with circular or elliptical polarization and an upward beam tilt. This mitigates detuning by local objects such as metal water pit lids or other surfaces whereby a wireless sensor or device may be mounted.

In the present embodiment, a bend in the first helix 1300 forms angle A from the departure of the feed point 1305. This angle A is selected based on the diameter of the helix H_{D} and pitch between successive turns 1307 (spacing) of the feed strip. As the angle A approaches ninety degrees, the helix becomes a straight wire with radiating properties similar to that of a wire antenna. On the other hand, as the angle A approaches zero degrees, the helix begins to form a loop antenna with similar radiating properties. The angle A for nominal radiation resistance is preferably between ten and thirty degrees though other angles are also possible. This same angle may also be used for the second helix.

In addition, the width of the conducting strips in each helix are approximately the same dimension for both first and second helixes. The separating dimension 1308 separates the first and second helixes. Selection of the diameter H_{D} of the antenna is based on the number of turns of the helix 1309 and the spacing between each turn 1307. These dimensions are preferably the same throughout the length of the antenna and are preferably common between both first and second helix.

To achieve the desired compactness the conductive radiators are made planar or in flat strips. The conductive radiators of the helix are flattened and are formed on the substrate, for example by etching the top and bottom layers of the substrate or as layers in a multi-layer substrate. Plated through holes or vias connect the conductive radiators on top and bottom layers. The pattern formed by the radiators is similar to that of a crisscross or a flattened spring.

To achieve a dual helix, an additional or second helix is located within a defined proximity to the first helix. The second helix of this example is fabricated in the same manner as the first helix. However, the second helix may alternatively be fabricated using a different process. Ends of both helixes may be connected together and the other ends are connected differently for proper operation. Specific embodiments of the antenna and the present invention are described in the following sections.

Although the first and second helix are shown in FIGS. 13A, 13B and 14 as having a counterclockwise rotational twist in the helical coiling direction away from the feed point, the invention also includes an antenna arrangement having a clockwise rotational twist in the helical coiling direction away from the feed point. Further, although the distance relationship between the first and second helix is shown in the helical coiling direction, the first and second helix may alternatively be separated in a different plane, for example in a direction perpendicular to the direction of the helical winding. For example, the first helix may be located outside (i.e., further away from the center of dimension H_{D}) of the coiling of the second helix. Further, the first and second helix may be arranged in an opposite relationship to that shown in FIGS. 13A, 13B and 14 in that the first helix connected to the feed point may be arranged above and further along the direction of helical coiling than the second helix which may be arranged inside and closer to the feed point than the first helix, differently than as shown in FIGS. 13A, 13B and 14.

Further, FIGS. 13A, 13B and 14 illustrate only a single ground plane located at one end of the antenna structure. However, other ground plane configurations are also included in the present invention. For example, the ground plane may extend in between the windings of sides 1316 and 1317 either partially or completely. Further, although the ground plane 1310 is shown having a straight edge perpendicular to the direction of helical coiling in a single dimension, other shapes of the ground plane 1310 are also included in the present invention. For example, the ground plane 1310 may have a curved edge having convex or concave curvature with respect to the plane perpendicular to the direction of helical coiling. Further the plane of the ground plane is preferably parallel to the direction of helical coil winding.

In the present embodiment, each of the conducting strips 1312 are fed through the substrate to the opposite side 1316/1317. This is done through the use of plated through holes 1301 or vias in a multi layer substrate (not shown). For example, as the strips are placed down on a first side of the substrate 1316, plated through holes 1301, having a width or diameter on the order of thirty thousandths of an inch (0.030″), may be used to electrically connect each strip to a strip on the other side of the substrate 1317. The substrate also includes the ground plane 1310 used to facilitate signal radiation. The size and shape of the substrate varies the radiating resistance of the antenna and other factors.

The low profile, compact planar antenna is configured using a dual helix to provide additional bandwidth enhancement. A flat, square printed circuit board may be used as the substrate where by the antenna is affixed although other convenient shapes are also included in the invention. Further, although two conductors are shown to form a dual helix, the invention also includes alternatively using more than two conductors to form a helix with multiple conductors. Some or all of the conductors are shorted together and/or connected to a feed point or feed points or ground.

FIG. 15 shows a further embodiment of the present invention. The present invention may be used in the application of various radio transceivers, such as handheld devices, wireless sensors, and the like. In fact, radio transceivers using the present invention can be used to an advantage when applied to remote sensing of water, gas, and electric metering. The low profile and high efficiency of the antenna are well suited for a battery powered sealed AMR transmitter 1318. Battery powered RF transmitter 1314 inside packaging 1315 is a used in conjunction with antenna 1313, as described above.

A further exemplary embodiment (not shown) includes a small, one square inch antenna for use on a wireless transmitter with a substrate consisting of FR4/G10 printed circuit board material with dielectric constant of approximately 4.5 to 5.0. The antenna is tuned to a center frequency of 920 MHz with a VSWR 2.0:1 bandwidth of 50 MHz. This is a five percent (5%) bandwidth of the operating frequency with an antenna length that is less than one tenth (0.1) of the operating frequency.

Background helical antennas use two dimensional ground planes located in the plane perpendicular to the direction of helical coiling of the antenna to enhance their performance. A conventional antenna having such a ground plane and with characteristics similar to those described above would be disadvantageously large. The present invention achieves advantageous results without using a two dimensional ground plane located in the plane perpendicular to the direction of helical coiling of the antenna.

A further exemplary embodiment of the present invention (not shown) includes a substrate smaller than that described above and having a center frequency increased to 1 GHz with a VSWR 2.0:1 bandwidth of 100 MHz. This embodiment results in a 10% bandwidth of the operating frequency with an antenna length less than one tenth of the operating frequency.

Thus, the present invention may be used to achieve an efficient, broadband antenna with a wide operating frequency range. Further, the present invention may result in a helical antenna that does not require a two dimensional ground plane perpendicular to the axis of the helical conductor. Further, the helical antenna according to the present invention may be fabricated with plural conductors on a planar substrate and may preserve the omni-directional radiation pattern, circular or elliptical polarization, and an upward beam tilt to facilitate electromagnetic fields generated by the antenna to radiate from a location having poor radio signal transmission characteristics, such as water meter pits.

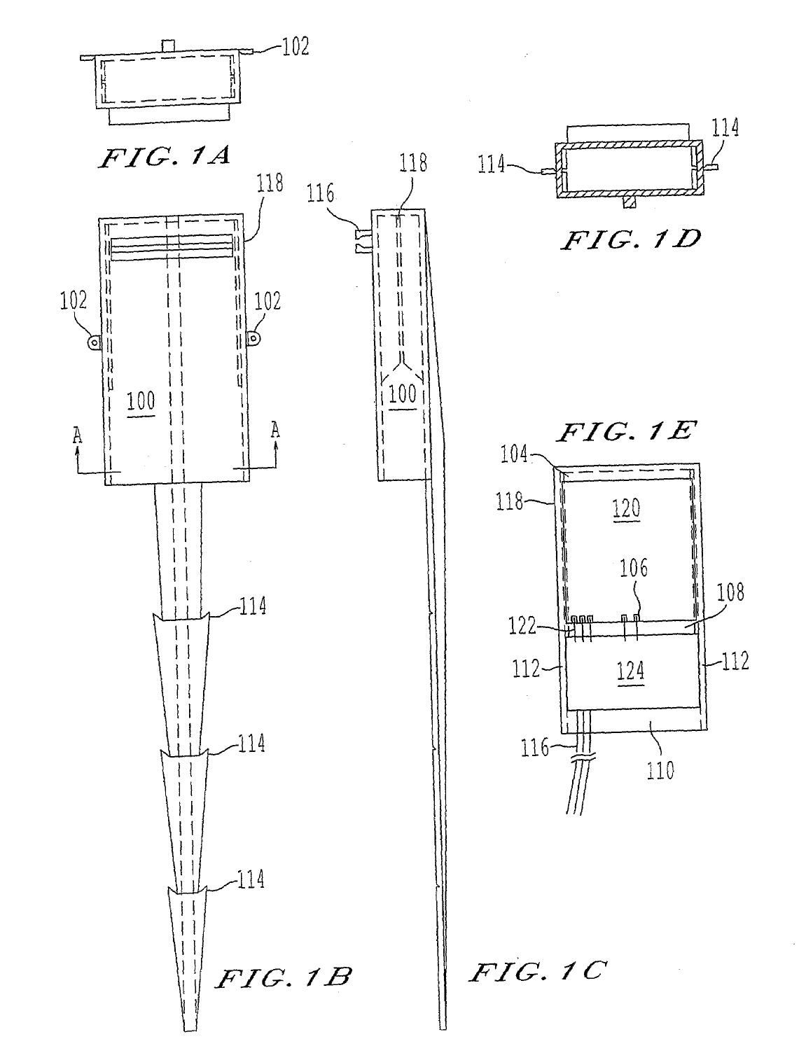

FIGS. 1A-1E show an example of a packaging arrangement suitable for use with an electronic device installed in a harsh environment, for example an electronic device that includes a transceiver, transmitter, or receiver including the antenna described above. However, the packaging in the present embodiment may also be used for other types of electronic devices. The omni-directional antenna resulting from the design described above advantageously allows a transmitter, receiver or transceiver to be placed in a location that has poor radio transmission characteristics, such as a water meter pit, or other location underground or below grade, or a location under a manhole cover or other locations with disadvantageous radio transmission characteristics. Further, the efficient and omni-directional radiation characteristics of the antenna described above allow it to be advantageously operated even from a location in which significant signal attenuation may result from the location.

In particular, FIGS. 1A, 1B and 1C show top, front and side views, respectively, of a packaging arrangement suitable for use with an electronic device. The package 100 includes internal grooves 118 that provide support for a printed circuit board 120 installed in the packaging. Alternatively, guide rails (not shown) may be used to support the printed circuit board 120. The package 100 optionally includes tabs 102 which may be used to mount the package 100 in an installed location. FIG. 1B also shows a ground stake including snap-off sections 114 that can be removed at installation time to result in a ground stake of an appropriate length. Thus, mounting stakes or screw tabs 102 or other convenient means may be used to affix the package in the installation location. Further, FIG. 1C shows coaxial clip 116 used to retain an optional external remote antenna (not shown) that may be coupled with the electronics inside the package 100 using a non-contact electrical connection method. For example, inductive coupling that does not require a hole through the external packaging may be used. A dielectric of the packaging material is preferably greater than or equal to 1 and less than or equal to 5.

FIG. 1D shows a cross-sectional view of the package from cross-section AA in FIG. 1B. The package 100 optionally includes snap-off tabs 104 that are useful for holding the package during fabrication thereof.

FIG. 1E shows a detailed view of one possible internal packaging arrangement of the apparatus. The outer portion of the package 118 contains a printed circuit board 120 installed in slots 118. The printed circuit board 120 includes solder tabs 106 and the solder tabs 106 are connected to wires 122 which in turn connect to battery pack 124. Battery pack 124 also includes external interface wires 116 which are a part of the battery pack and which extend outside of the packaging. The package assembly includes a protective air gap at one end of the printed circuit board 104 and also includes an air gap at the other end of the printed circuit board 108. The air gap 108 also allows a convenient place for the package to be cut for replacement of the battery if desired. Further, epoxy or other sealant 112 is used to affix battery pack 124 inside the packaging and also to provide a seal between the external environment and the cavity in which printed circuit board 120 is installed. In addition, the apparatus includes cavity 110 providing an additional location for epoxy or another sealant to be located to further protect the printed circuit board from the external environment.

Thus, in the present embodiment the external wires and other connections between the printed circuit board and the external environment are formed as a part of the battery pack which also provides an environmental seal between the cavity in which the printed circuit board is installed and the external environment, thereby providing additional protection from the external environment.

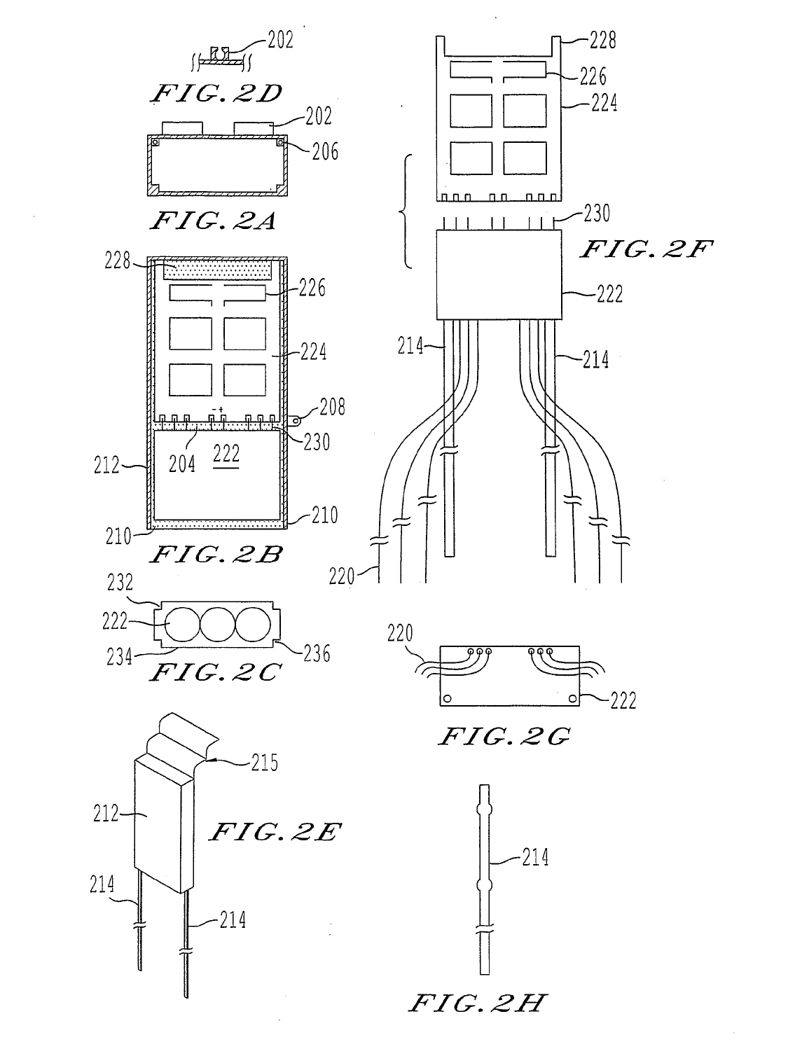

FIGS. 2A, 2B and 2C show top, front and bottom views of a further embodiment of the present invention. FIG. 2A shows a printed circuit board 224 that includes standoffs to create a gap 228 between antenna 226 and any external structure that may be outside the package, for example a metal lid for a water pit (not shown). Antenna 226 may be an antenna of any manufacturer or may preferably be an antenna according to the helical antenna structure described above. Wires 230 connect battery pack 222 to printed circuit board 224.

FIG. 2D shows a side view of coaxial antenna clips 202. Further, the package optionally includes mounting posts 214 which may be affixed to the package using mounting post holes 206. Alternatively, the package may be mounted in the installed location using optional breakaway mounting tabs 208. A sealant that includes rubber, RTV, epoxy or other similar sealing material may be used to fill cavities 228, 204 and 210 to protect the printed circuit board from the environment. Battery pack 222 may be held in place by the epoxy or alternatively may be a tight fit or rubberized battery pack held in place by friction. In addition, cavity 204 is placed such that a circular saw may be used to cut through the package and separate the battery pack from the printed circuit board if subsequent retrofit is desired. Wires 220 extend from the battery pack to provide communication access between the printed circuit board and the external environment.

FIG. 2C shows a bottom view of an exemplary battery pack, which includes a clearance area 232 for these meter wires and the package also includes clearance area 236 for holes 206 to mount the external posts.

FIGS. 2F and 2G show further detailed views of a possible embodiment of the present invention. FIG. 2H shows a detailed view of a possible embodiment of the mounting posts 214.

FIG. 2E shows a perspective view of the package 212 with installed mounting posts 214 as well as optional corrosion prevention tab 215. The corrosion protection tab 215 includes plastic, lead or other non-corrosive material used as an alternative method of mounting the electronic package inside a water pit or other enclosed space with a lid. For example, corrosion prevention tab 215 extends between a lid and a lid seat and the material of the corrosion prevention tab prevents the lid from corroding and attaching itself permanently to the lid seat. Further, the corrosion prevention tab 215 prevents pit lid rust from scaling the RF path of the electronic apparatus. Further, mounting posts 214 extend into soil if necessary to keep the apparatus from falling when a lid of an enclosure is removed and the corrosion prevention tab 215 is no longer affixed in place.

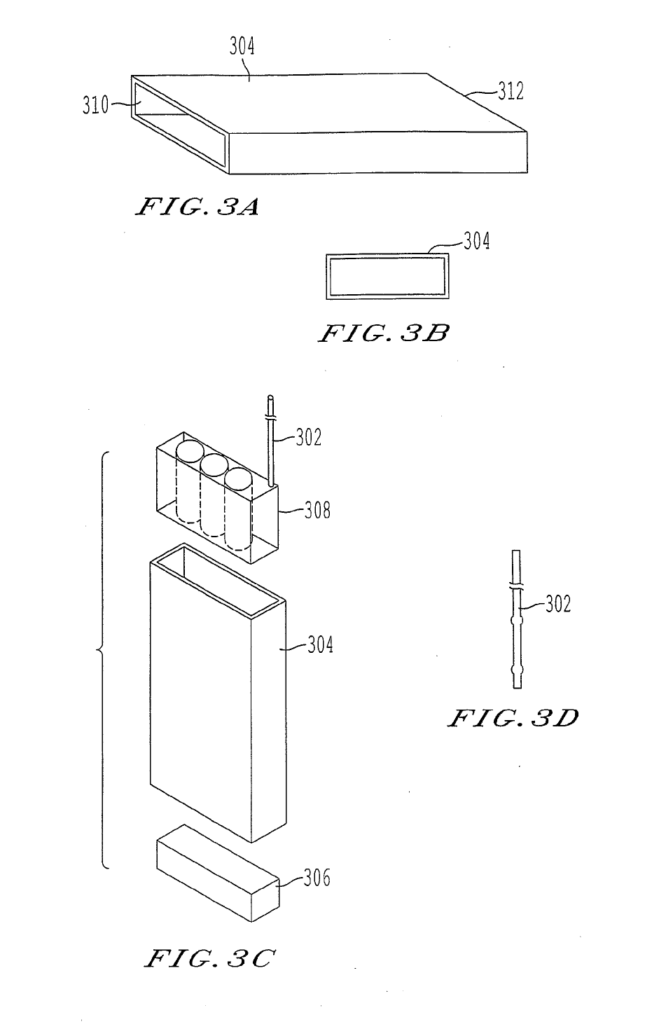

FIG. 3A shows a perspective view of a plastic tube, for example an extruded plastic tube, which may be used in an alternative possible embodiment of the present invention. A dielectric of the plastic tube is preferably greater than or equal to 1 and less than or equal to 5. The plastic tube 304 is open at both ends 310 and 312. A front view of the extruded tube is shown in FIG. 3B. FIG. 3C shows a possible method of construction of a completed package. For example, a plug 306 or epoxy may be filled into the bottom end of the tube 304. Subsequently, a printed circuit board (not shown) may be installed inside the tube 304. Next, a battery assembly 308, having support post 302, may be is installed into the opposing end of the extruded tube to complete the assembly of the apparatus and package. Although the battery assembly 308 is shown including three cylindrical batteries, other quantities or shapes of batteries may also be used. FIG. 3D shows a detailed example of mounting post 302.

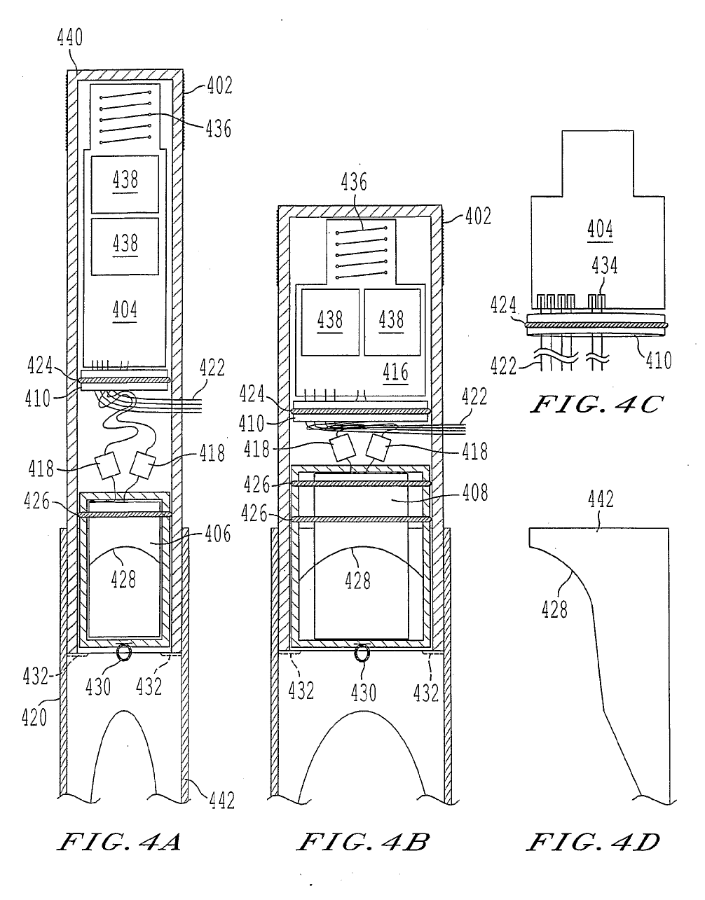

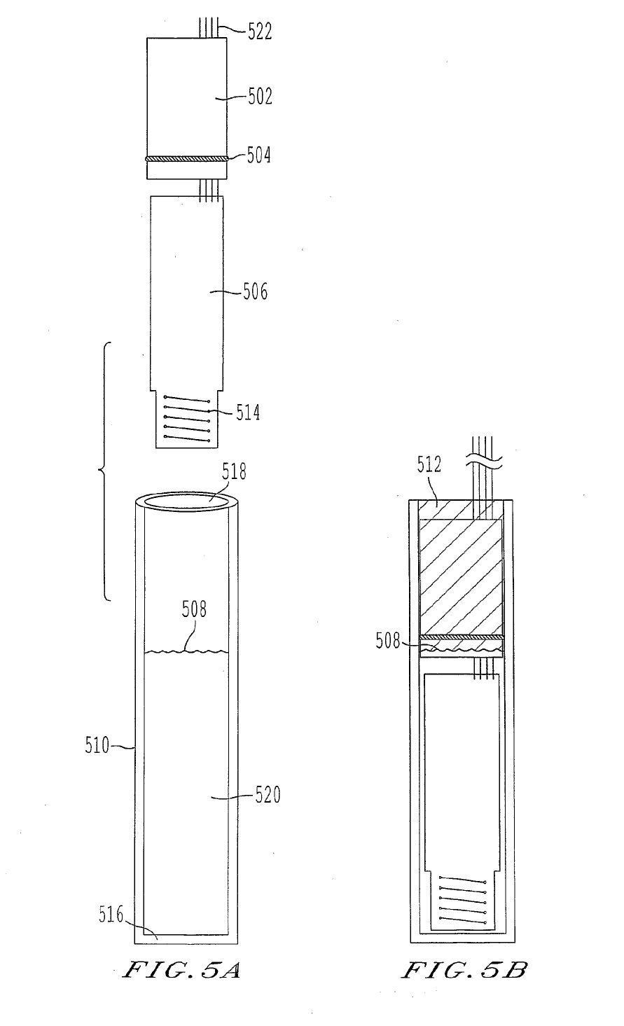

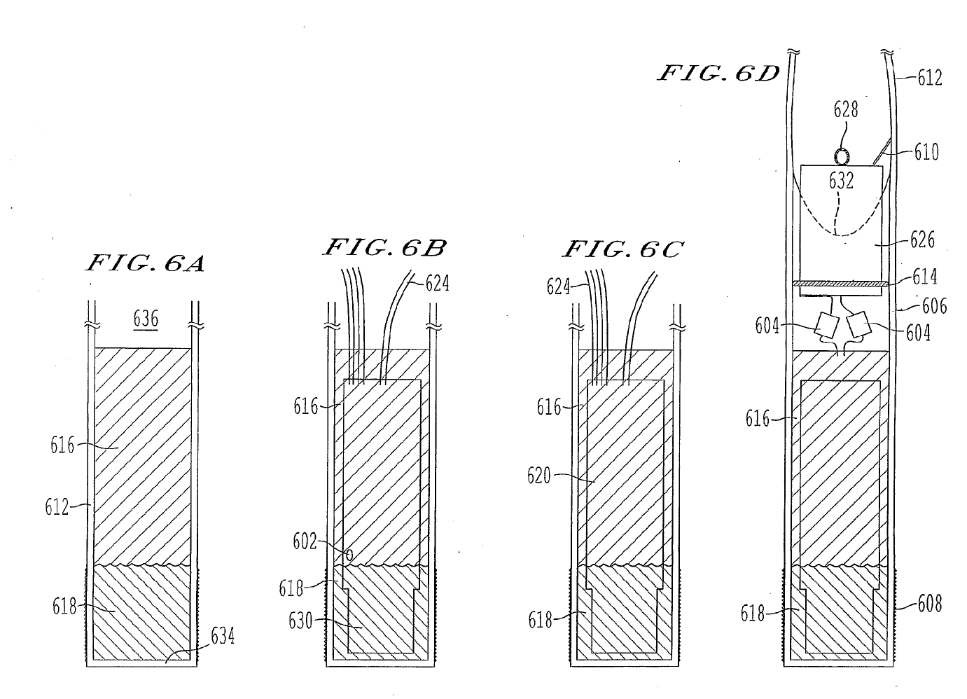

FIG. 4A shows a further possible embodiment of a package 420 for an electronic device according to the present invention. The package includes a first pipe or cylindrical tube 440 that is closed at one end (top end as shown in FIG. 4A) and open at an opposite end. A dielectric of the tube is preferably greater than or equal to 1 and less than or equal to 5. The tube 440 provides a protective enclosure for an electronic apparatus such as printed circuit board 404 which includes electronic devices 438 and antenna 436, for example. Antenna 436 may be an antenna according to the helix antenna invention described above. The electronic package includes gasket 424 to isolate the electronic section from the external environment. The package may also include gasket 426 around battery assembly 406 to further protect the electronic device from the external environment. In the present embodiment external access wires 422 which connect to the printed circuit board are shown exiting the tube 440 through a side hole. The side hole may be filled with a gasket or other sealant. Alternatively, wires 422 may connect to battery assembly 406 and feed out through the lower end of the tube as in the previous embodiment discussed above. In addition, the present embodiment includes crimp connectors 418 to provide an electrical connection between the printed circuit board and the battery assembly 406. Battery assembly 406 includes an extraction clip 430 which is used to easily remove and install the battery assembly 406. Further, clips 432 are used to hold the battery assembly in place inside the tube. In addition, connector assembly 410 may protect the printed circuit board 404 from stress or strain associated with wires 422 and protect the printed circuit board from the external environment. Pads 434 on printed circuit board 404 may connect to the wires 422. A partial tube 442 provides one possible method of supporting a tube package according to the present invention. The partial mounting tube 442 includes a cut-away section 428 which allows access to install and remove the battery assembly 406.

FIG. 4D shows a side view of partial mounting tube 442. FIG. 4B shows an alternative embodiment including a larger battery (e.g., D cell) and a different printed circuit board configuration (e.g., printed circuit board 416) and additional isolation gasket 426, but is otherwise similar to the embodiment shown in FIG. 4A. Tube 440 also includes optional threads 402 at the closed end which may be used for mounting the tube to an installation location. Further, tube 440 may also include optional threads at the open end (not shown) used to mount an optional cover for the open end (not shown), or to attach the tube 440 to an external device or structure (not shown).

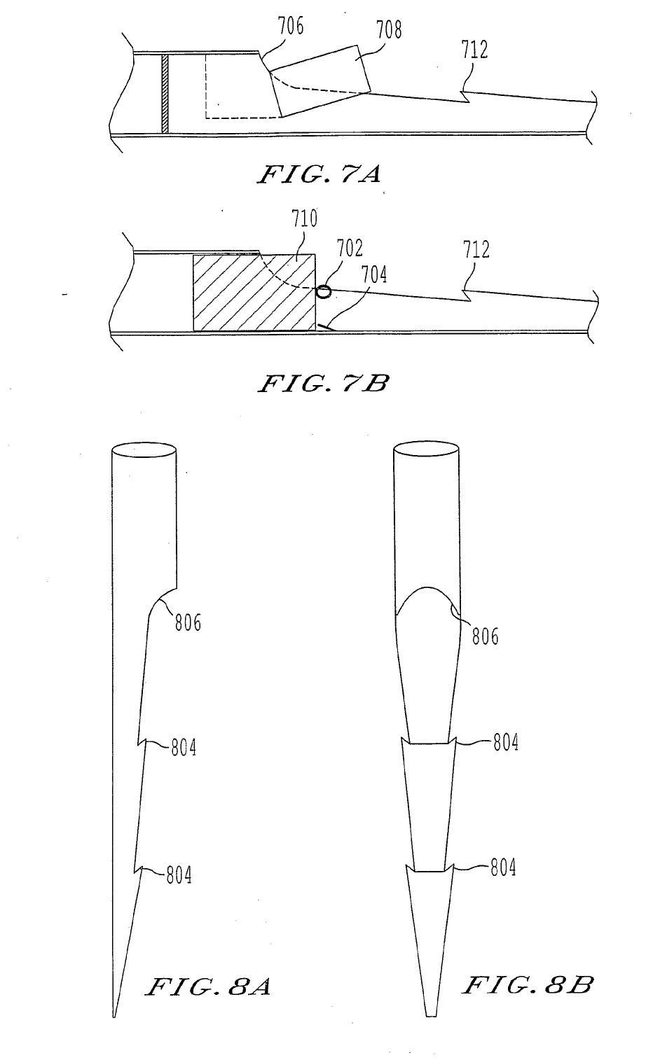

FIGS. 5A and 5B show an example of a method of manufacturing an apparatus according to the present invention. FIG. 5A shows a tube 510 having one open end 518 and one closed end 516 that is partially filled with a RF transparent fluid 520. In particular, the RF transparent fluid allows a component of an RF signal between 890 MHz and 960 MHz to be attenuated by less than 50% when passing through the liquid. The RF transparent fluid 520 is non-corrosive and is intended to remove air from the portion of the tube in which it is located. The RF transparent fluid 520 is filled in the tube part way up to liquid level 508. Next, a printed circuit board 506 having antenna 514 and connecting to battery assembly 502 having gasket 504 and external wires 522 is installed in the tube partially filled with RF transparent fluid 520. Next, the portion of the tube not filled by the RF transparent fluid 520 is optionally filled with epoxy or other sealant to retain the RF transparent fluid 520 within the tube and to prevent external moisture from entering the cavity where the printed circuit board 506 is located. Further, although printed circuit board 506 is shown with a dual helical antenna 514 similar to that described above, other antennas are also possible with the present invention.

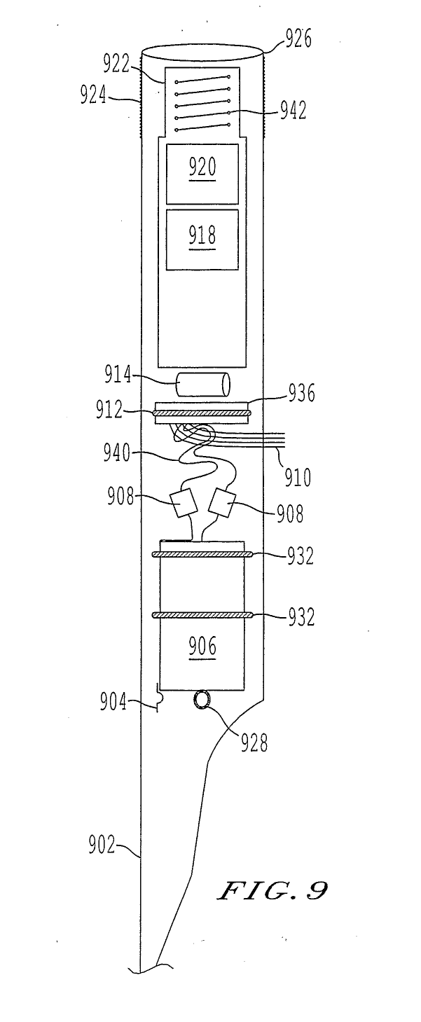

FIGS. 6A-6D show a further possible method of manufacturing an apparatus according to the present invention. In FIG. 6A, cylindrical tube or pipe 612 includes one closed end 634 and one open end 636. The tube is partially filled with protective foam 618 and region 616 is not filled with protective foam or other material. Subsequently, as shown in FIG. 6B, a printed circuit board assembly having an antenna mounted at one end 630 is inserted in the tube such that the antenna 630 is surrounded by the protective foam 618. The protective foam 618 has a dielectric that is similar to air which is advantageous for the operation of the antenna. In particular, the dielectric of the foam is preferably greater than or equal to 1 and less than or equal to 3. Further, the foam is soft when initially added to the cylindrical tube 612 and when the antenna 630 is installed in the tube. However, the foam becomes stiff prior to normal use of the apparatus. Further, the printed circuit board having antenna 630 also includes a mag loop receiver 602 in this embodiment. Further, the printed circuit board also includes wires 624 which provide an electrical interface between the printed circuit board and devices outside the packaging tube 612. Subsequent to installing the printed circuit board assembly within the tube 612 the foam 618 is allowed to dry, and then subsequently an epoxy material is added to fill area 616. Alternatively an epoxy material may be used to fill the entire space around the printed circuit board 620, as shown in FIG. 6C. Further, as shown in FIG. 6D the completed assembly may also include battery 626 retained by retention clip 610 with extraction ring 628 and gasket 614. Further, battery assembly 626 may be connected to the printed circuit by crimp connector 604, or other similar connectors. In addition, the tube 612 may include threads on the closed end 608 for mounting. In addition, tube 612 may include battery access cutout 632 and thus does not require the separate tube or partial mounting tube shown in FIGS. 4A, 4B, 4C and 4D.

FIG. 7A shows a side view of a package according to the present embodiment that includes battery cutaway 706 through which battery assembly 708 may be installed or removed. Further, this side view shows breakaway point 712 at which the end of the mounting tube may be broken away, for example, to simplify staking the tube into the ground. FIG. 7B shows an alternative possible embodiment with a sealed type battery assembly 710 installed via the access hole 706. The sealed battery 710 may be retained in place via battery clip 704 and may be extracted with the assistance of extraction ring 702.

FIGS. 8A and 8B show side and front views, respectively, of an embodiment of the present invention including battery extraction cutaway 806 and optional breakaway points 804.

FIG. 9A shows an alternative possible embodiment of the present invention including a partially cutaway cylindrical tube 902 having a sealed end 926 and threaded portion 924. In the present example, the package includes printed circuit board 922 configured to perform a metering function or other portable device function and having antenna 942 and electronic components 918 and 920 (e.g., finnal amp and VCO/synthesizer). Further, in the present embodiment, the printed circuit board 922 is connected (not shown) to a super capacitor 914 which reduces reliance on cell capacitors (not shown), and sealing assembly 936 which includes gasket 912 to protect printed circuit board assembly 922 from the external environment. Wires 910 extend outside the tube enclosure 902 to interface with external devices. Further, battery assembly 906 includes gaskets 932 and is connected via crimp connectors 908 to the printed circuit board assembly 922. A service loop 940 is depicted to indicate that the wires connecting the battery assembly 906 to the printed circuit board assembly 922 may have extra length to allow easy insertion and removal of the battery assembly. Further, extraction of the battery assembly is aided by extraction ring 928 and battery retention clip 904 retains battery in place when extraction is not desired.

FIG. 10 shows a possible installation of the apparatus. In this example, the apparatus 1012 is staked into the ground via stake 1004. Further, the apparatus is located within a subterranean pit 1018, for example a water pit having water meter 1006 connected to water pipes 1014. Further, the water meter 1006 of this example includes electronic interface 1008 connected via wires 1010 to the electronics within the apparatus of the present invention 1012. However, the invention also includes water meters or other electronic devices located outside the package that communicate with the package electronics without the use of wires (e.g., using radio signals, optical signals, inductive links or other wireless communication methods).

Alternatively, although the water meter is shown with an electronic interface 1008 shown in a separate enclosure from the package described herein, the present invention also includes embodiments having the transceiver electronics and the meter interface electronics or the entire meter enclosed within a common package. Further, the water pit is covered by a pit lid 1002 which is metal or plastic, for example. Further, the pit lid 1002 is seated in a ground seat 1016. Further, although the cutaway battery access portion of the present invention is shown underground, the stake may also be installed in the ground such that the battery portion remains exposed to the air.

FIG. 11A shows a further possible embodiment of the present invention in which an apparatus such as described above 1106 is installed in a pit lid 1108 having a central hole 1110. The pit lid sits on top of pit lid walls 1112. Further, as shown in FIG. 11B, a bottom side knot washer 1104 may be threaded onto the electronic packaging 1106. The electronic packaging 1106 extends through the central hole in a pit lid 1108 and a cap 1102 is threaded on the exposed end of the packaging apparatus 1106. The cap 1102 and bottom side nut 1104 washer affix the apparatus 1106 to the pit lid 1108. Further, the cap 1102 may be fabricated from plastic or other RF transparent material to improve the ability of the RF signals transmitted or received from the electronic apparatus to be transmitted successfully. In addition, although this embodiment includes alternatively connecting the apparatus to pit lid 1108, the apparatus may also be configured to operate when completely enclosed by a pit lid of any material. In particular, the combination of the invention described herein and a suitable communication technique, for example the boost mode communication technique described in related U.S. patent application Ser. No. 10/662,530 may result in the ability to successfully communicate from within an enclosure, such as a water pit, regardless of enclosure or pit lid construction or materials.

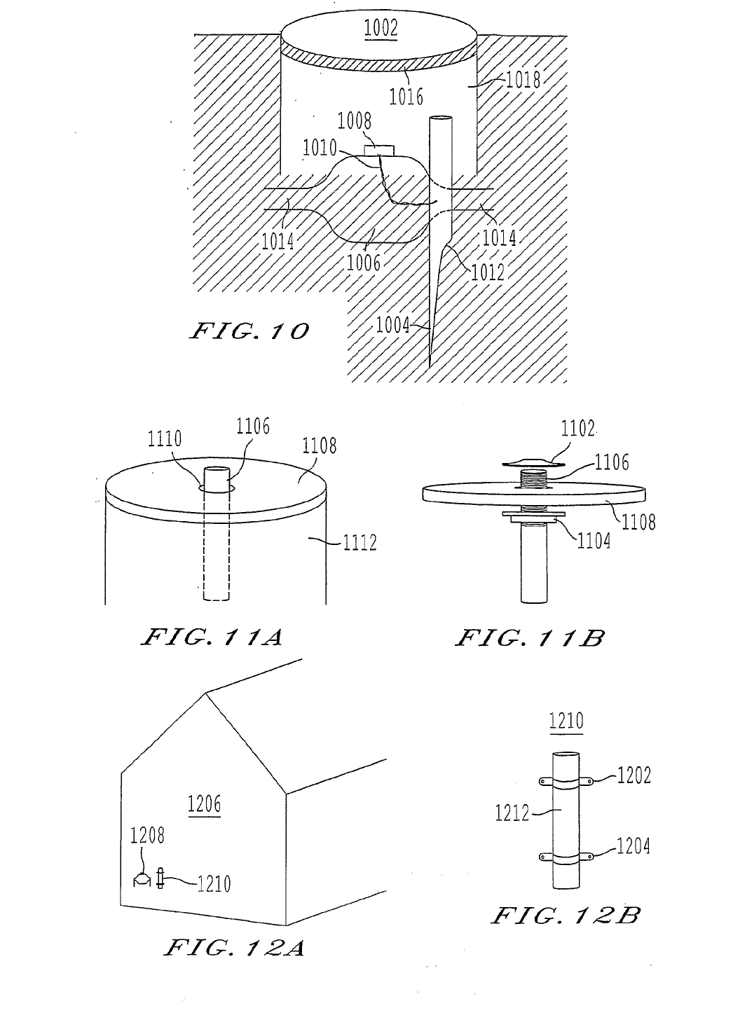

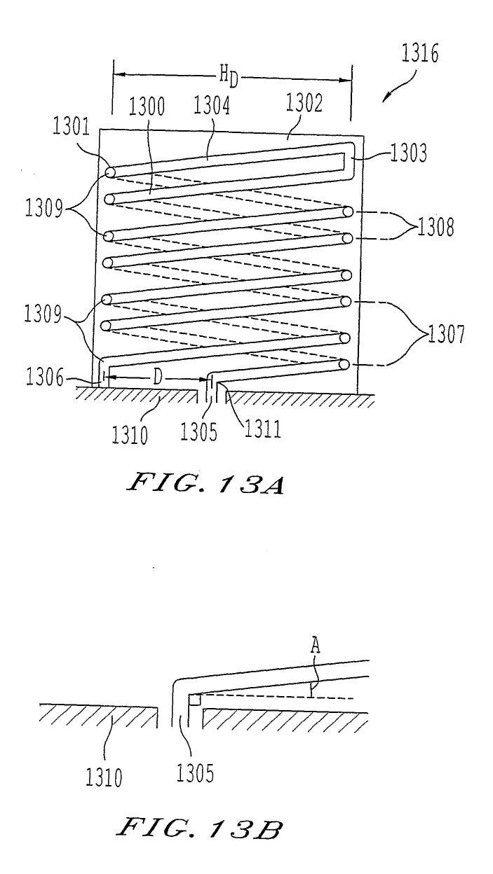

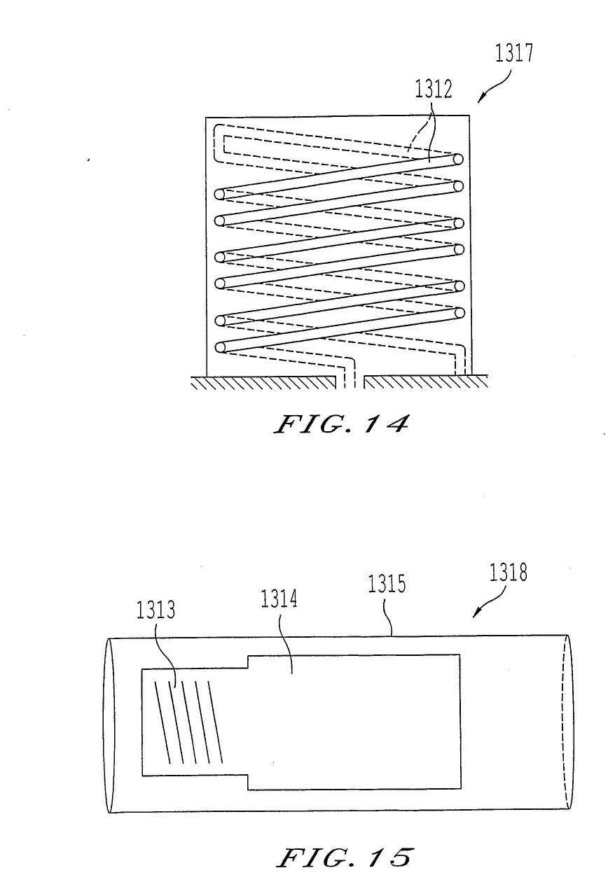

FIG. 12A shows an alternative possible embodiment of the present invention including the packaged electronic apparatus 1212 mounted inside a structure 1206, for example as a gas, water, security or other commercial sensor apparatus. For example, the apparatus 1212 may be mounted close to a gas meter 1208 located inside a home 1206. Further, as shown in FIG. 12B, the apparatus 1212 may be mounted to a wall of the house 1206 using brackets 1202 and 1204.

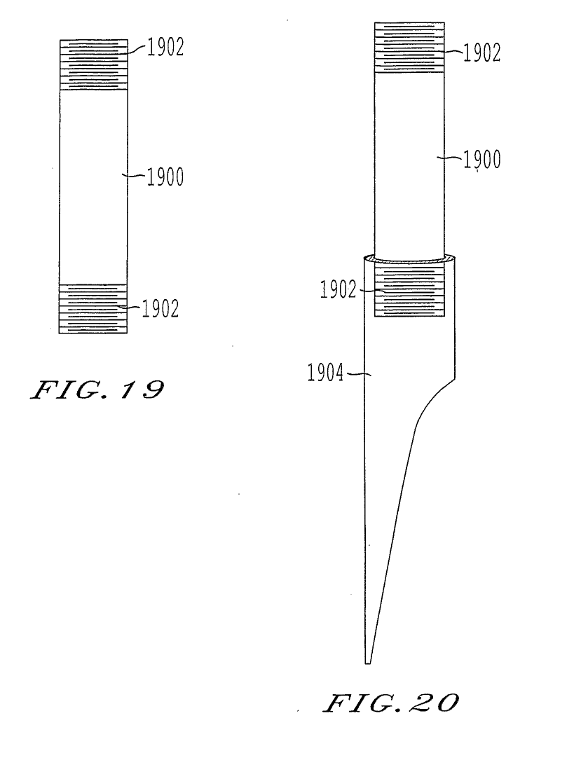

FIG. 16 shows an example of a circular corrosion prevention ring 1602 according to a further embodiment of the present invention. FIG. 17 shows an example of a crescent corrosion prevention ring 1604 according to a further embodiment of the present invention. FIG. 18 shows an example of using a circular or crescent corrosion prevention ring 1804 to at least partially isolate a metal pit lid 1802 from a pit lid seat 1806 at the top of a pit 1808. The circular or crescent corrosion prevention ring 1804 includes a non-corrosive material, such as aluminum or plastic (e.g., aluminum foil), and prevents or limits the ability of the pit lid 1802 from disadvantageously rusting or corroding in a way that would make it difficult to remove the pit lid 1802 from pit lid seat 1806. A partial circumferential length C of the crescent corrosion prevention ring 1604 is preferably greater than ½ the wavelength of a communication radio frequency used by a radio frequency communication device operating from within the pit.

FIG. 19 shows an alternate embodiment of a package including threads 1902 at both ends of housing 1900. The threads may be used to attach the housing to a pit lid as discussed above. In addition, the threads may be used to attach the pipe to other devices not shown, for example a meter outfitted with threads, a water pipe “T” junction or similar water pipe, or an optional mounting platform or stake. The threads advantageously provide a secure, rigid and compact means for fixing the package 1900 in place. In addition, by including threads on the lower portion of the package, a package including a short range wireless interface (for example, an inductive coupling) at the lower portion of the package may advantageously be mounted in close proximity to a short range wireless interface on another package (for example, an inductive coupling on a water meter) to allow communication between the electronics within the package and electronics in another package, without having an opening in the outside wall of the package. Thus, this embodiment may further limit the intrusion of moisture into the package.

FIG. 20 shows an embodiment of the package in FIG. 19 having lower threads attached to a mounting stake 1904. The mounting stake can be used to secure the package 1900 in soil within a subterranean enclosure, like a water pit.

FIG. 21A shows an embodiment of an apparatus according to the present invention that includes a wireless short range pickup 2110, for example an inductive pickup or short range radio frequency device. The wireless short range pickup 2110 may be used to communicate with another device outside the package, for example a water meter (not shown). The wireless short range pickup 2110 is operatively connected to other devices within the package, including for example, a meter interface with wireless short range pickup interface 2106, microcontroller 2104, radio frequency circuit 2102 and antenna 2100. The wireless short range pickup 2110 may be mounted separately from the circuit board mounting the devices described above, may be mounted to the battery pack 2108, or may be mounted in other ways such that the wireless short range pickup interface 2106 is within range of another pickup located outside the package.

FIG. 21B shows a possible arrangement of batteries 2112 in battery pack 2108. The batteries may include series DL 123 3V cells, or other batteries suitable to meet the power and packaging requirements of the apparatus. The batteries may be connected in series or in parallel as required.

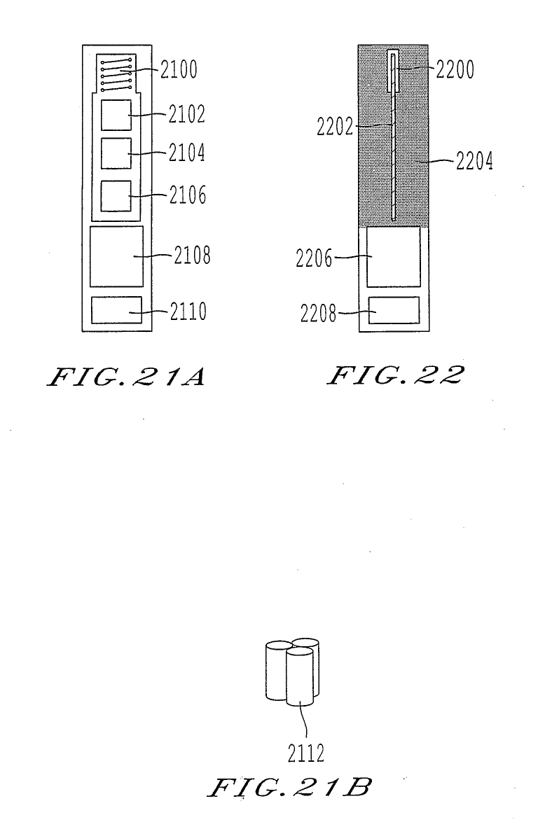

FIG. 22 shows an alternative packaging method according to the present invention. The method includes creating an air gap around the antenna prior to filling the package with a watertight material 2204, such as epoxy or solid plastic. The air gap may be created by an air gap enclosure 2200 to keep the watertight material 2204 away from the antenna mounting region (not shown) of a circuit board 2202. The air gap enclosure 2200 may include, for example, a plastic clamp, cup, cap or housing. The air gap enclosure 2200 preferably includes a low dielectric material, or a material with a dielectric similar to air. In particular, the dielectric of the low dielectric material is preferably greater than or equal to 1 and less than or equal to 3. Alternatively, the air gap enclosure 2200 may be an air region created in the interior portion of an injection molding of the package. Such an injection molded package includes an air gap enclosure 2200 to maintain an air filled region around an antenna. Alternatively, the air gap enclosure 2200 may be filled with a low dielectric foam to keep the watertight material 22204 away from the antenna mounting region. The air gap enclosure 2200 may also include a seal (not shown) such as an adhesive, pressure fit or gasket seal, to prevent watertight material 2204 from entering the air gap region. The apparatus shown in FIG. 22 also includes a battery pack 2206 and an optional inductive pickup 2208.

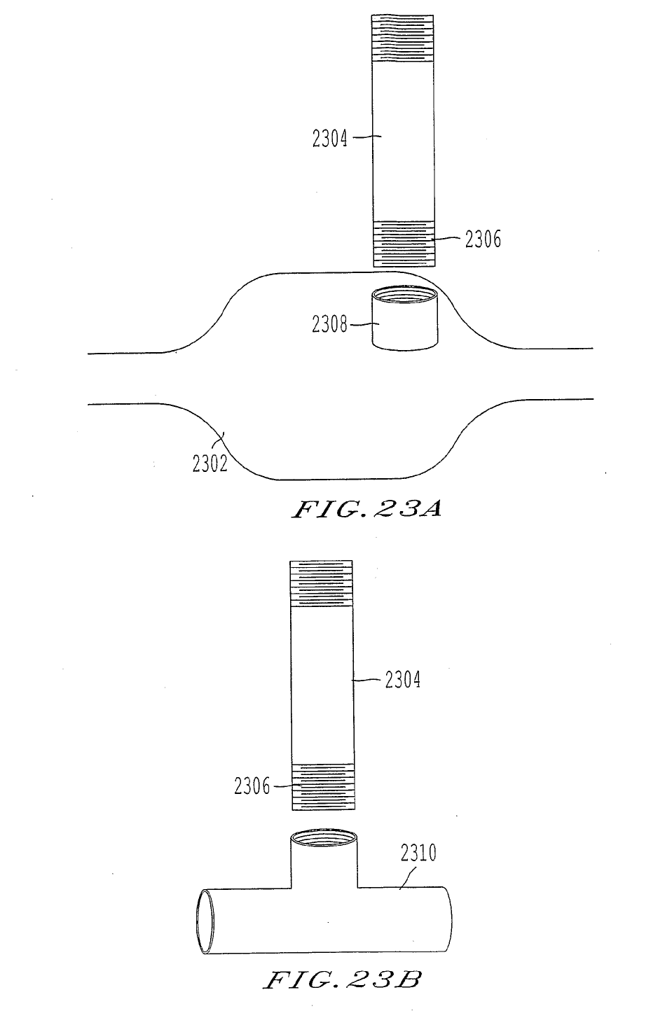

FIGS. 23A and 23B show alternative possible mounting arrangements for the present invention. FIG. 23A shows an embodiment of the present invention including transceiver tube 2304 having lower threads 2306. Lower threads 2306 may be connected to water meter 2302 using threaded fitting 2308. FIG. 23B show an embodiment in which transceiver tube 2304 is connected to “T” junction 2310 using lower threads 2306.

Although the present inventions are described above using embodiments related to water meter applications, the present inventions are not limited to only water meter applications but apply to other applications, including control and monitoring of gas and electric utilities, control and monitoring of voltage and current, security applications, environmental monitoring, irrigation control and monitoring, industrial control and monitoring, fluid or gas flow control and monitoring, temperature control and monitoring, pressure control and monitoring, weight control and monitoring, vibration control and monitoring, and vibration monitoring for predictive machine failure annunciation, for example.

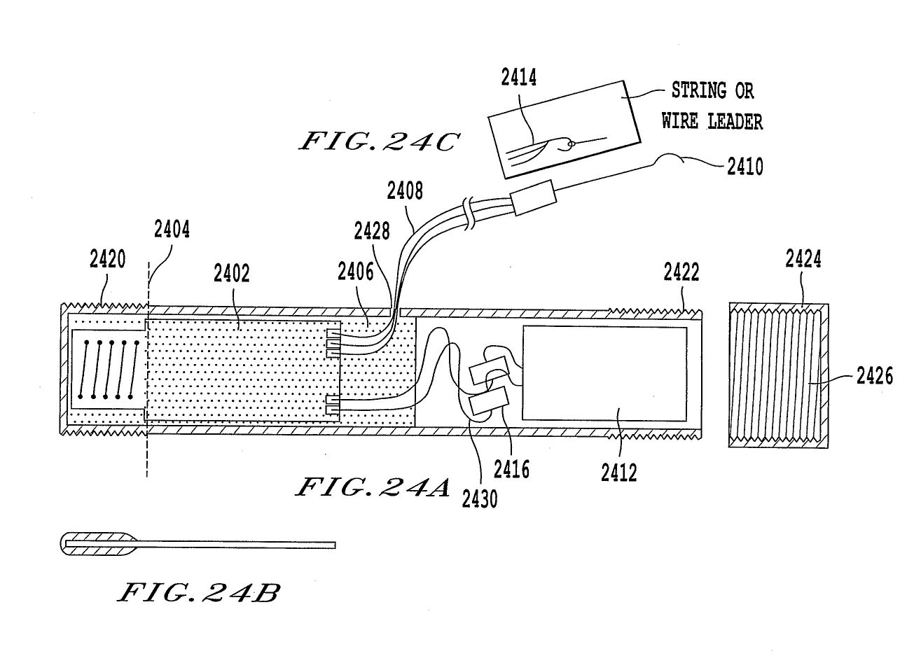

FIG. 24A includes a further example of a method of manufacturing according to the present invention. In this example, a transceiver tube includes a first thread 2420 at one end, a second thread 2422 at a second end and contains a circuit board 2402 having an antenna region 2418. The circuit board 2402 is attached to wires 2408 for external interfaces and power wires 2430. Power wires 2430 connect to gell caps 2416, which in turn connect to a battery 2412. An opening at one end of the transceiver tube may be covered using threaded cap 2424. Optionally, the first thread 2420 and second thread 2422 may be different sizes or types to reduce the likelihood that the transceiver tube is installed in the incorrect orientation (e.g., upside-down).

A first manufacturing step, according to the present example, includes filling the closed portion of the tube with a foam having a dielectric that is suitable for radio frequency transmission, up to the location indicated by label 2404, and inserting the circuit board 2402 and into the tube such that the antenna region 2418 of the circuit board 2402 is within the foam. In particular, a dielectric of the foam is preferably greater than or equal to 1 and less than or equal to 3. Alternatively, an air gap may be created around the antenna region 2418 of the circuit board 2402 using a clamp, for example as shown in the partial side view of FIG. 24B. A second manufacturing step includes pulling wires 2408 through hole 2428 using a string 2410 or wire leader 2414, for example as shown in FIG. 24C. A third manufacturing step includes sealing hole 2428 with a sealant such as glue (e.g, from a hot glue gun) or a prefabricated plug (not shown). A fourth manufacturing step includes adding a filling material 2406, such as epoxy or plastic filler, to the closed end of the tube such that the filling material 2406 covers at least a portion of the circuit board 2402 and the inside portion of hole 2428. A fifth manufacturing step may include attaching the gell caps 2416 and battery assembly 2412 to wires 2430. A sixth manufacturing step may include filling the threaded cap 2424 with an air sealant 2426, such as grease or plumber's glue, and attaching the cap 2424 to the tube by the second threads 2422.

FIG. 25 shows a further embodiment of the present invention including tube 2510 with external attaching device 2508, such as a clip or clamp, used to hold an external assembly 2506, such as an external battery housing. In the present example, external housing 2506 includes battery 2504 connected to gell caps 2502, which in turn are connected to devices within tube 2510. A filling material 2512 may optionally fill the voids within the external assembly 2506 around the battery 2504.

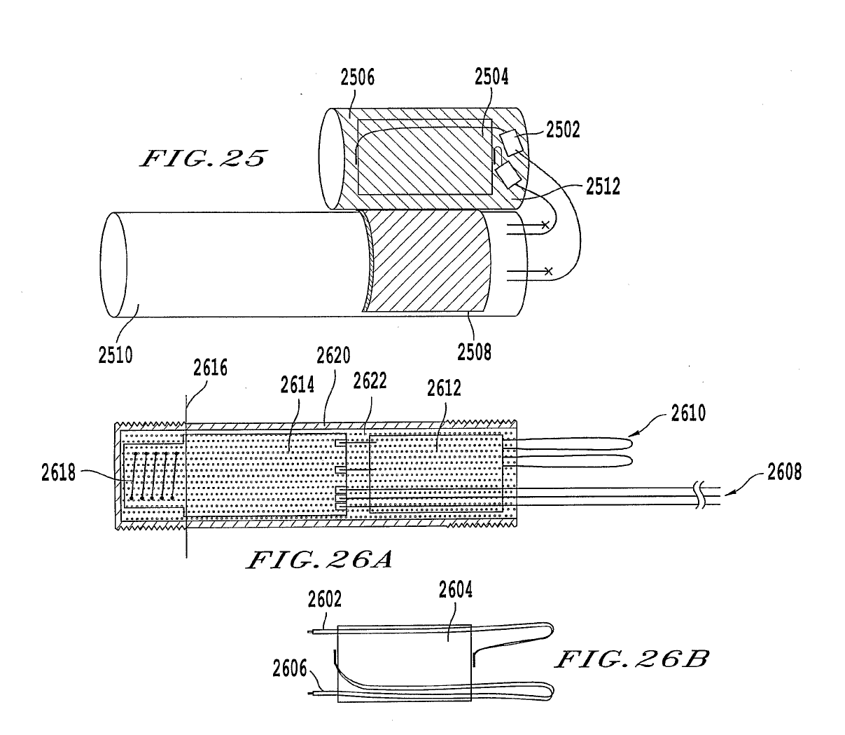

FIG. 26A shows a further embodiment of the present invention including tube 2620. A first manufacturing step of the present embodiment includes filling a closed end of tube 2620 with a foam having a suitable dielectric for RF transmission to the location identified by label 2612. In particular, a dielectric of the foam is preferably greater than or equal to 1 and less than or equal to 3. An alternative first manufacturing step is to dip a portion of the circuit board 2614 into a foam having a suitable dielectric for RF transmission or to create an air cavity around the antenna region 2618 using a clamp (not shown). A second manufacturing step includes inserting circuit board 2614, attached battery 2612, attached power loop wires 2610 and attached interface wires 2608 into tube 2620. A third manufacturing step includes filling the region around the circuit board 2614 with a filling material 2622, such as epoxy or plastic fill. The power loop wires 2610 may extend outside of the region of filling material 2622 so that power may be optionally disabled or to allow the internal battery to be removed from loop and a new cell with gell-cap connectors (not shown) to be optionally attached.

FIG. 26B shows a detailed view of a wiring arrangement according to the embodiment shown in FIG. 26A. In this arrangement, a battery 2604 is attached to wires 2602 and 2606 to create power loops similar to those shown in FIG. 26A. The battery 2604 may include any suitable power cell(s), such as one or more AAA, AA, C, D or DL123 cells connected in series, in parallel, or in a combination of series and parallel connections.

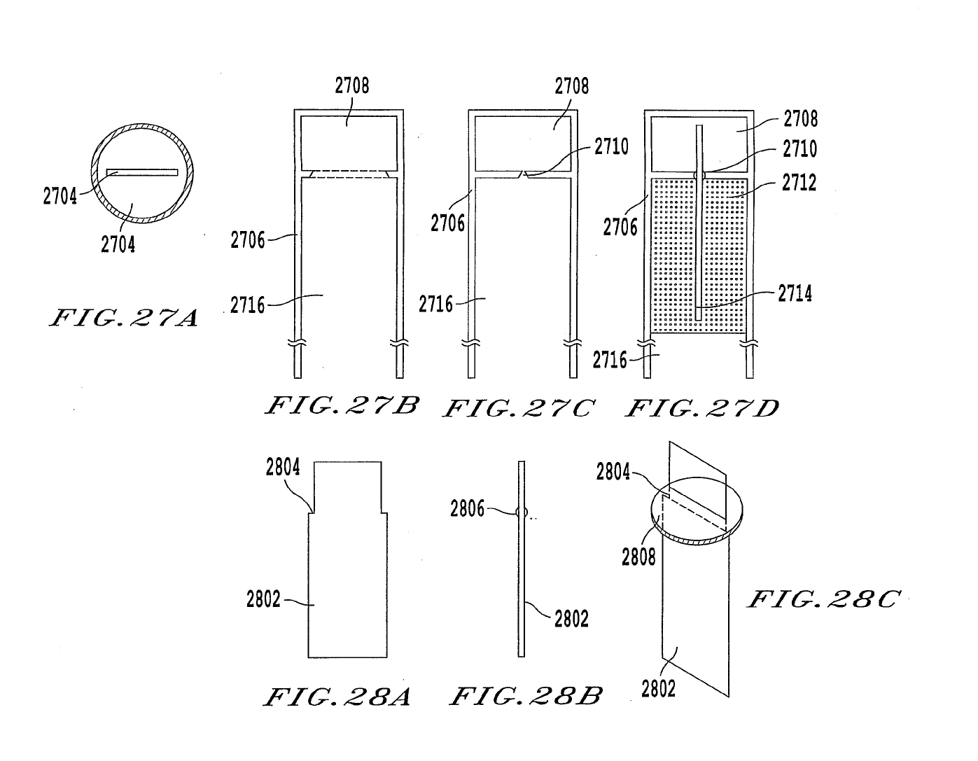

FIGS. 27A-27D show an embodiment of the present invention including a tube 2706 having a first cavity 2708 and a second cavity 2716. The first and second cavities are separated by a bulkhead 2704 having an opening 2702. The tube 2706 may be manufactured using a cavity forming technique, for example, a casting technique, an injection molding technique or a machining technique. The bulkhead opening 2702 may optionally include squeeze fitting 2710 that fits tightly over a printed circuit board 2714 that may be inserted through the opening 2702. Alternatively, the opening 2702 may include a sealant 2710, such as epoxy, plastic, silicone or other sealant material. A circuit board 2714 may be advantageously arranged to include an antenna portion in the part of the circuit board that extends into the first cavity 2708. A potting material 2712 may be added to the second cavity 2716 to prevent environmental deterioration of the circuit board 2714, and components thereon (not shown), including the antenna.

FIGS. 28A and 28B show further embodiments of a circuit board 2802, similar to the circuit board 2714 shown in FIG. 27D. The circuit board 2802 includes an indentation 2804 located at the start of an antenna containing region of the circuit board (not shown). An optional sealant 2806, such as a gasket or silicon glue may be applied to the circuit board. The sealant 2806 may advantageously seal the antenna region (e.g., first cavity 2708) from a potted region of the circuit board (e.g., second cavity 2716), as shown in FIG. 27D.

Numerous modifications and variations of the present invention are possible in light of the above teachings. It is therefore to be understood that within the scope of the appended claims, the invention may be practiced otherwise than as specifically described herein.

1. An antenna, comprising:
a printed circuit board having opposed first and second surfaces;
first and second conductive traces formed on said first and second surfaces, wherein,
the first traces are longitudinally extending and parallel to each other, and the second traces are longitudinally extending and parallel to each other,
at least one pair of the first traces or one pair of the second traces are shorted together, and
plural of the first traces have ends connected to ends of respective of the second traces through vias that pass through the printed circuit board; and
third and fourth conductive traces having first ends respectively connected to a signal feed point and a ground point and second ends connected to respective of said first and second traces.

2. The antenna of claim 1, further comprising a radio frequency receiver on the printed circuit board.

3. The antenna of claim 1, further comprising a radio frequency transmitter on the printed circuit board.

4. The antenna of claim 1, further comprising:
a moisture resistant container configured to attach to a lid of a subterranean enclosure, said printed circuit board being mounted inside the container.

5. The antenna of claim 4, wherein a dielectric of the moisture resistant container is greater than or equal to 1 and less than or equal to 5.

6. The antenna of claim 1, wherein a dielectric of the printed circuit board is greater than or equal to 4.5 and less than or equal to 5.0.

7. The antenna of claim 4, wherein the moisture resistant container includes screw threads configured to attach to a threaded hole in the lid.

8. The antenna of claim 4, wherein the moisture resistant container includes a tab configured to be compressed between the lid and a lid seat.

9. The antenna of claim 4, wherein a shape of said container is cylindrical and is configured to extend through a hole in the lid of the subterranean enclosure.

10. The antenna of claim 1, wherein each of the third and fourth traces include a bend of a predetermined bend angle α; and
an angle θ between said first traces and said second traces follows an equation θ=π−2α.

11. A low profile, broadband antenna for use with a source of RF energy comprising:
a printed circuit board (PCB) substrate having a minute thickness and dimensions approximately to that of a square, said antenna including a dual helical structure for bandwidth enhancement and an omni-directional radiation pattern.

12. The antenna of claim 7, further configured not to include a ground plane perpendicular to an axis of the dual helix antenna parallel to a first direction of the third trace or any additional ground plane(s) to enhance performance.

13. The antenna of claim 7, wherein an antenna length is significantly less than the wavelength of the antenna operating frequency.

14. A method of making an antenna, comprising steps of:
forming a printed circuit board having opposed first and second surfaces;
forming first and second conductive traces on said first and second surfaces, wherein,
the first traces are longitudinally extending and parallel to each other, and the second traces are longitudinally extending and parallel to each other,
at least one pair of the first traces or one pair of the second traces are shorted together, and
plural of the first traces have ends connected to ends of respective of the second traces through vias that pass through the printed circuit board;
connecting first ends of third and fourth conductive traces to a signal feed point and a ground point, respectively; and
connecting second ends of third and fourth conductive traces to said first and second traces, respectively.

15. An electronic device, comprising:
a moisture resistant container configured to attach to a lid of a subterranean enclosure; and
a printed circuit having an antenna and electronic components mounted inside the container.

16. The electronic device of claim 15, wherein a dielectric of the moisture resistant container is greater than or equal to 1 and less than or equal to 5.

17. A method of manufacturing an electronic device, comprising steps of:
partially filling a moisture resistant shell with a foam;
inserting a printed circuit board having an antenna into the shell such that the antenna is covered by the foam; and
filling the portion of the shell that does not have foam with a potting material to hermetically isolate a region inside the shell including the printed circuit board from the outside of the shell.

18. The method of claim 17, wherein a dielectric of the foam is greater than or equal to 1 and less than or equal to 3.

19. A method of manufacturing an electronic device, comprising steps of:
partially filling a moisture resistant shell with a liquid;
inserting a printed circuit board having an antenna into the shell such that the antenna is covered by the foam, said antenna being configured to operate at a predetermined RF frequency; and
filling the portion of the shell that does not have foam with a potting material to hermetically isolate a region inside the shell including the printed circuit board from the outside of the shell.

20. The method of claim 19, wherein a component of an RF signal at the predetermined frequency passing through the liquid is attenuated by less than 50%, said predetermined frequency being between 890 MHz and 960 MHz.
